(19) United States
(12) Patent Application Publication
(10) Pub. No.: US 2004/0264060 A1
(43) Pub. Date: Dec. 30, 2004

(54) Stacked actuator arm assembly with registration washer

(76) Inventor: Aaron Steve MacPherson, Fort Collins, CO (US)

Correspondence Address: Derek J. Berger, Seagate Technology LLC, Intellectual Property-COL2LGL, 389 Disc Drive, Longmont, CO, 80503, US

(21) Appl. No.: 10/607,326

(22) Filed: Jun. 26, 2003

(51) Int. Cl. G11B 5/55

(52) U.S. Cl. 360/265.7

(57) ABSTRACT

A stacked actuator arm assembly has an actuator arm and spacer stacked on a rotatable pivot bearing sleeve. The stacked actuator arm assembly has a nut washer on the pivot bearing sleeve where the nut washer has an extension to maintain its proper position. One spacer has an overmold, and the actuator arm is registered in rotational position to the overmold. A load beam for each actuator arm has its proximal end attached to the actuator arm and its distal end supporting a read/write head. A clamping nut is threaded on the sleeve to clamp the actuator arms and spacers together. A registration nut washer is registered in rotational position to the overmold so that, as the nut tightens down on the stacked actuator arm assembly, the nut washer does not rotate relative to the actuator arms and spacers. The registration nut washer has a key extension that engages a slot in the overmold to register the nut washer in rotational position to the overmold. Alternatively, the registration nut washer has an extension for a hole receiving a threaded pin to fasten the actuator assembly together, and this hole extension engages a registration surface on the overmold to register the nut washer in rotational position to the overmold.

### FIELD OF THE INVENTION

This application relates generally to disc drives and more particularly to a stacked actuator arm assembly in a disc drive. The stacked actuator arm assembly has a registration nut washer.

### BACKGROUND OF THE INVENTION

A typical disc drive includes a base to which various components of the disc drive are mounted. The components include a spindle motor, which rotates one or more discs at a constant high speed. Information is written to and read from tracks on the discs through the use of an actuator arm assembly, which rotates during a seek operation about a bearing shaft assembly positioned adjacent the discs. The actuator arm assembly may include a plurality of actuator arms, which extend towards the discs, with one or more head suspension assemblies extending from each of the actuator arms. Each head suspension assembly includes a flexure or load beam and a head mounted on a gimbal assembly at the distal end of the load beam. Each head includes an air bearing slider enabling the head to fly in close proximity above the corresponding surface of the associated disc. Head suspension assemblies are typically attached to the corresponding metallic actuator arms by a metallic spring member spot welded to the metallic load beams and to the metallic actuator arms. The spring member biases the head suspension assembly towards the surface of the disc.

During a seek operation, the track position of the heads is controlled through the use of a voice coil motor, which typically includes a coil attached to the actuator assembly, as well as one or more permanent magnets, which establish a magnetic field in which the coil is immersed. Application of current to the coil causes the coil to move. As the coil moves, the actuator assembly pivots about the bearing shaft assembly, and the heads are caused to move across the surfaces of the discs.

During the manufacture of an actuator arm assembly it is most important that the alignment of the stacked elements of the assembly be maintained in alignment during the tightening down of the nut that clamps the actuator arms on the pivoting shaft of the assembly. If the stacked elements are not aligned, the assembly will not be as rigid as it should be and there will be misalignment of the heads carried by the arms relative to each other.

### SUMMARY OF THE INVENTION

Against this backdrop the present invention has been developed. The invention features a disc drive stacked actuator arm assembly having a nut washer on a pivot bearing sleeve where the nut washer has an extension to maintain its proper position. An actuator arm and a spacer are stacked on the sleeve which is rotatably mounted on the base of the disc drive. The spacer has an overmold, and the actuator arm is registered in rotational position to the overmold. A load beam for the actuator arm has its proximal end attached to the actuator arm and its distal end supporting a read/write head. A clamping nut is threaded on the sleeve to clamp the actuator arm and spacer together. A registration nut washer is registered in rotational position to the overmold so that, as the nut tightens down on the stacked actuator arm assembly, the nut washer does not rotate relative to the actuator arm and spacer.

In another aspect of the invention the actuator arm, the spacer and the registration nut washer of the actuator assembly all have two holes on opposite sides of the actuator assembly. The holes are aligned through the stacked actuator arm assembly, and a threaded pin passes through each the holes and is fastened at the nut washer to provide additional clamp pressure and rigidity to the stacked actuator arm assembly.

In another aspect of the invention a plurality of actuator arms and two or more spacers are mounted on the sleeve. Each of the actuator arms and spacers are registered in rotational position to the overmold.

As an additional feature of the invention the registration nut washer has a key extension that engages a slot in the overmold to register the nut washer in rotational position to the overmold. Alternatively, the registration nut washer has an extension for a hole receiving a threaded pin to fasten the actuator assembly together, and this hole extension engages a registration surface on the overmold to register the nut washer in rotational position to the overmold.

These and various other aspects and features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a perspective bottom view of an stacked actuator arm assembly illustrating a registration nut washer according to an embodiment of the present invention.

FIG. 3 is a perspective bottom view of the stacked actuator arm assembly illustrating a registration nut washer according to another embodiment of the present invention.

FIG. 4 is an exploded view of the stacked actuator arm assembly of FIG. 2.

### DETAILED DESCRIPTION

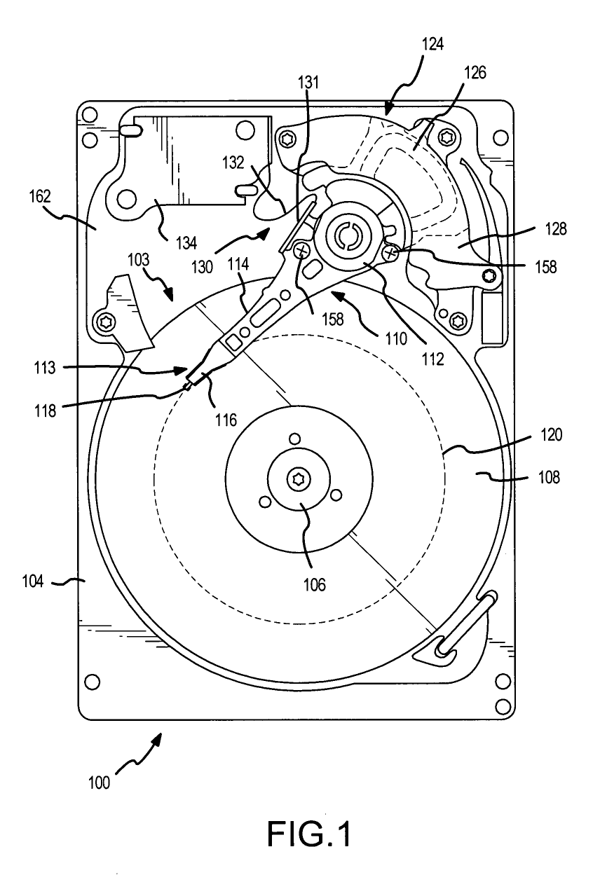

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 103 at a constant high speed. Information is written to and read from tracks on the discs 103 through the use of an actuator assembly 110, which rotates during a seek operation about a bearing shaft assembly 112 positioned adjacent the discs 103. The actuator assembly 110 includes a plurality of stacked, symmetrical actuator arms 114 which extend towards the discs 103, with one or more head suspension assemblies 113 extending from each of the actuator arms 114. Each head suspension assembly includes a load beam 116, a gimbal assembly (not visible) mounted at the distal end of the load beam and a head 118 mounted on the gimbal assembly. Each actuator arm 114 is a metal arm on which at least one head suspension assembly is mounted. Each head 118 includes an air bearing slider enabling the head 118 to fly in close proximity above a corresponding recording surface 108 of the associated disc 103.

During a seek operation, the track position of the heads 118 is controlled through the use of a voice coil motor 124, which typically includes a coil 126 attached to the actuator assembly 110, as well as one or more permanent magnet 128, which establish a magnetic field in which the coil 126 is immersed. Preferably, the coil 126 is formed as an integral part of a plastic mold extension—the overmold—of at least one actuator arm 114. The controlled application of current to the coil 126 causes magnetic interaction between the permanent magnet 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 103.

A flex assembly 130 provides the requisite electrical connection paths for the actuator assembly 110 while allowing pivotal movement of the actuator assembly 110 during operation. The flex assembly includes a printed circuit board 131 attached to one side of the stack of actuator arms 114 and a flex cable 132. Head wires (not shown) are connected to the printed circuit board; the head wires are routed along the actuator arms 114 and the load beams 116 to the heads 118. The printed circuit board 131 preferably includes circuitry for controlling the write currents applied to the heads 118 during a write operation and a preamplifier for amplifying read signals generated by the heads 118 during a read operation. Additionally, the portion of the head wires that are routed along the actuator arms 114 are preferably a flex circuit attached to actuator arms 114 and load beams 116. The flex assembly also includes a flex cable 132 that extends from the circuit board 131 and terminates at a flex bracket 134. The flex bracket 134 communicates through the base deck 102 to a disc drive printed circuit board (not shown) mounted to the bottom side of the disc drive 100.

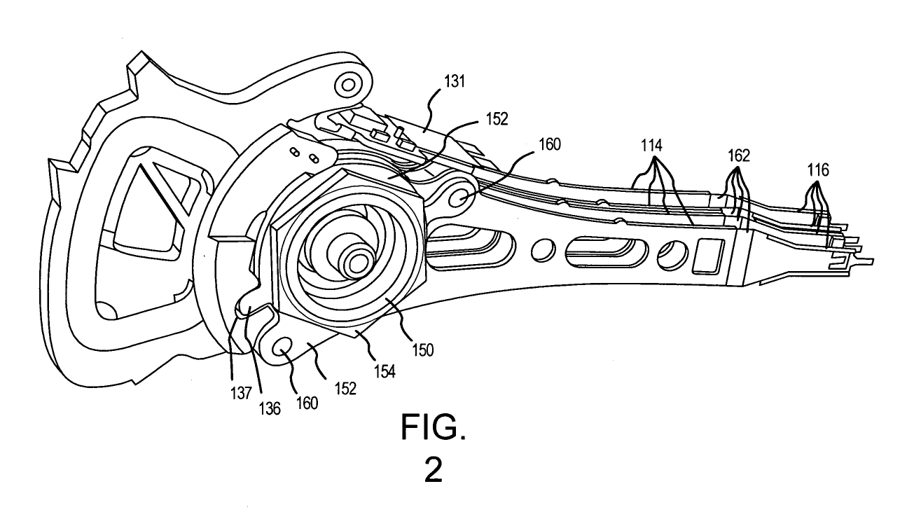

Referring now to FIG. 2, one embodiment of the stacked actuator arm assembly with registration nut washer is shown in a bottom perspective view. In this embodiment the registration nut washer 135 has a key extension 136 that engages a slot 137 in the overmold 156. The stacked assembly is made up of four actuator arms 114 with a spacers between the outer actuator arms and the inner actuator arms. The actuator arms and the spacers are stacked on sleeve 150 of bearing shaft assembly 112 (FIG. 1). A nut washer 135 is placed between the last actuator arm on the stack and a clamping nut 154. Nut 154 is threaded on the bottom of sleeve 150 to clamp the stacked actuator arm assembly together. The nut washer serves to distribute the compression load of the nut on the stacked assembly as the nut is tightened down.

Printed circuit board 131 is attached at one side of the actuator assembly through a solder screw that engages one of the spacers. The spacer closest to the nut washer 135 and nut 154 has a plastic mold extension (also referred to herein as the overmold) 156. The overmold 156 carries the coil 126 of the voice coil motor.

In addition to the nut 154 holding the stacked actuator arm assembly together, there are also provided two threaded pins, (bolts or screws) 158 (FIG. 1) that pass through aligned holes in all of the stacked actuator arm assembly elements and are threaded into the holes 160 in nut washer 135. The screws 158 serves multiple functions. They provide fasteners in addition to nut 154 to hold the stacked actuator arm assembly together, and they compress the stack of elements making the stacked actuator arm assembly more rigid.

The load beams 116 are attached to the actuator arms by spring members 162 which provide a spring force to load the heads 118 (FIG. 1) adjacent the surface of the discs 103 (FIG. 1) as the heads are flying above the surface. A flex cable (not shown) passes from the printed circuit board 131 to the actuator arms to the load beams and ultimately to the heads 118.

The registration nut washer 135 in addition to providing the threaded holes 160 into which screws 158 are screwed also provides a registration extension 136. The nut washer registration extension 136 engages a tight tolerance (relative to extension 136) slot 137 in the overmold 156. This serves to precisely register holes threaded 160 to receive screws 158 passing through the actuator stack. Accordingly the actuator arm assembly can be initially held together with pivot bearing sleeve 150 and nut 154 tightening down to clamp the stack of actuator components together. The actuator arms and spacers may be aligned by keys in the arms and spacers and slots in the overmold. Alternative the arms and spacers might be aligned in a jig while the pivot bearing sleeve and nut are installed to clamp the actuator arm assembly together.

Another function of the registration extension or key on the nut washer 135 is to prevent the washer 135 from rotating as nut 154 is rotated to tighten down on the stacked assembly. If the washer 135 were to rotate, this would put a rotational load on the actuator arms and spacers in the stacked actuator assembly during installation of nut 154. In effect the actuator arms would be biased to rotate or fan out as the nut 154 is tightened. The registration extension or key prevents this rotation of actuator arms and spacers because the key abuts against a wall of slot 137 in the overmold 156. For example, if the nut were rotated clockwise to clamp the actuator arm assembly together, the nut washer 152 is held in place and does not rotate because it abuts a wall of slot 137 in the clockwise direction. Since the washer does not move relative to the overmold 156, the actuator arms and spacers remain in alignment as registered with the overmold as the nut clamps the assembly together. Now the screws 158 can be passed through holes and arms and spacers of the stack and screwed into threaded holes 160 in the registration washer to further clamp the assembly together and add to the rigidity of the stacked actuator arm assembly.

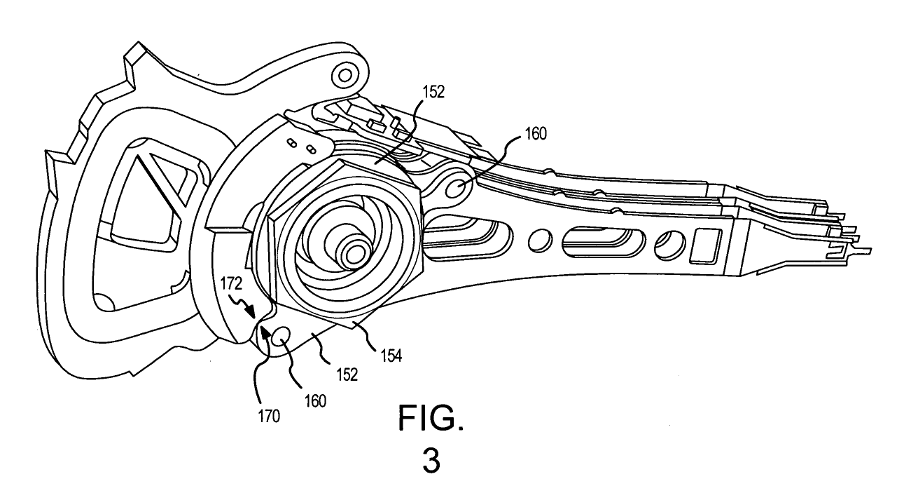

FIG. 3 shows an alternative embodiment of the invention where the registration nut washer 152 is registered to the overmold 156 by the structural device of a beak shaped hole extension 171 of nut washer 152. The beak 170 protrudes to one side of hole extension 171. Hole extension 171 contains one of the threaded holes 160. The beak 170 engages registration surface 172 of the overmold 156 to register the nut washer 152 in rotational position to the overmold. This prevents the washer from rotating with nut 154 as the nut is tightening down to clamp the actuator arm assembly together. Thus the registration nut washer is registered against the surface 172 of the overmold 156, and this prevents nut 154 from transmitting a rotational load to the actuator arms and spacers relative to the overmold as the nut is tightened down to compress and clamp the actuator arm assembly together.

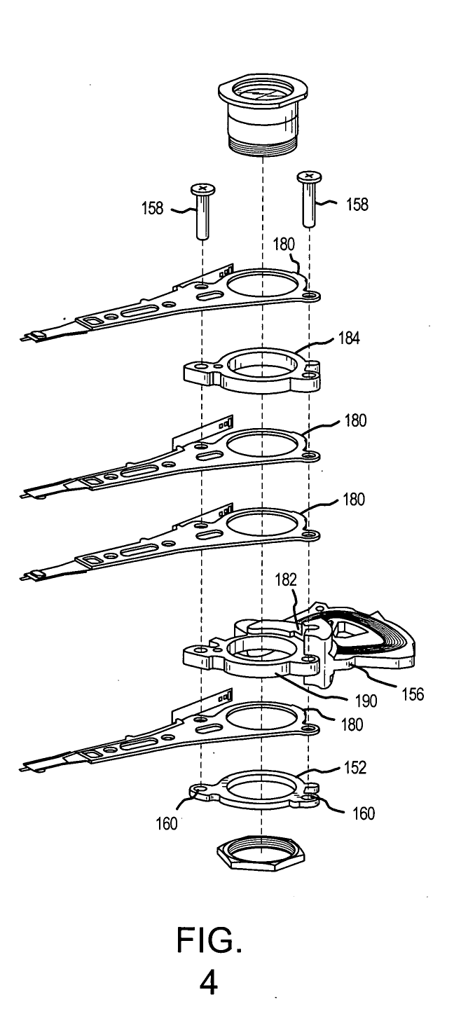

FIG. 4 shows an exploded view of the actuator arm assembly and illustrates how the actuator arms and spacers are registered to the overmold 156 so that the arms and spacers are properly aligned. Common elements in FIGS. 1, 2 and 4 have been given the same reference numeral. Each of the arms 114 is registered to overmold 156 by key extensions 180 that engage slots 182 (lower slot not visible) in the overmold. Spacer 184 has key extension 186 that engage slot 188 in the overmold 156. Spacer 190 carries the overmold 156. The registration nut washer shown in FIG. 4 is the same as the nut washer in the embodiment of FIG. 2.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, many different registration element shapes may be used to position the registration nut washer in accordance with the present invention. Numerous other changes may be made which will readily suggest themselves to those skilled in the art and which are encompassed in the spirit of the invention disclosed and as defined in the appended claims.

What is claimed is:

1. A data storage device comprising:
a storage medium; and
an actuator for accessing the storage medium, the actuator comprising:
a rotatable sleeve;
an actuator arm mounted to the sleeve;
a first spacer mounted to the sleeve and contacting the actuator arm;
a nut threaded on the sleeve to clamp the actuator arm and spacer together; and
a registration nut washer engaging the nut, the washer further comprising a protrusion which engages a portion of the spacer, such that as the nut tightens down on the stacked actuator arm assembly the nut washer does not rotate relative to the spacer.

2. The data storage device of claim 1 wherein the registration nut washer distributes the compression load from the nut on the stacked actuator arm assembly as the nut is rotated on the sleeve to tighten down on the stacked actuator arm assembly.

3. The data storage device of claim 1 in which the actuator arm, the spacer and the washer all have first holes aligned with one another, the actuator further comprising:
a pin passing through the holes.

4. The data storage device of claim 3 in which the pin is fastened to the nut.

5. The data storage device of claim 4 in which the nut includes an extension with an aperture, such that the pin is fastened to the nut by insertion into the aperture.

6. The data storage device of claim 5, in wich the pin and the aperture are threaded.

7. The data storage device of claim 3 wherein the actuator arm, the spacer and the registration nut washer all have second holes aligned with one another on an opposite side of the actuator from the first holes, the actuator further comprising:
a pin passing through the second holes.

8. The data storage device of claim 1 further comprising:
at least one additional actuator arm and at least one additional spacer mounted on the sleeve.

9. The data storage device of claim 1 wherein the registration nut washer protrusion comprises a key extension that engages a slot in the spacer portion to register the nut washer in rotational position to the spacer portion.

10. The data storage device of claim 1 in which the spacer postion comprises an overmold.

11. The data storage device of claim 1 in which the storage medium comprises a rotatable disc.

12. The data storage device of claim 1 further comprising:
a load beam attached having a first end attached to the actuator arm and a second end supporting a read/write head.

13. A disc drive comprising a plurality of rotatable discs and a stacked actuator assembly operable to move at least one read/write head over each recording surface of the rotatable discs, the actuator assembly comprising:
a plurality of actuator arms, each arm carrying a read/write head;
a sleeve rotatable mounted on the disc drive and carrying the actuator arms in stacked array along the axis of the sleeve;
one or more spacers also mounted on the sleeve, a spacer being mounted between actuator arms carrying read/write heads for opposite sides of a rotatable disc so that the spacer provides separation between the arms to accommodate the rotatable disc positioned between the arms; and
at least one of the spacers having an overmold to provide a rotational registration surface for the actuator arms; and
a registration nut washer registered in rotational position to the overmold so that a clamping nut on the sleeve does not put a rotational load on the actuator arms relative to the overmold as the nut is tightened down on the actuator assembly.

14. The disc drive of claim 13 wherein the actuator arm, the spacer and the registration nut washer of the stacked actuator assembly all have two holes on opposite sides of the actuator assembly aligned through the actuator assembly, and the actuator assembly further comprises:
a threaded pin passing through each of the holes and being fastened at the nut washer to provide additional clamp pressure and rigidity to the actuator arm assembly.

15. The disc drive of claim 14 wherein the actuator assembly comprises in addition:
a plurality of actuator arms and two or more spacers are mounted on the sleeve;
each of the actuator arms and spacers being registered in rotational position to the overmold.

16. The disc drive of claim 14 wherein the registration nut washer in the actuator assembly has a key extension that engages a slot in the overmold to register the nut washer in rotational position to the overmold.

17. The disc drive of claim 14 wherein the actuator arm, the spacer and the registration nut washer in the actuator assembly all have at least one hole aligned through the stacked actuator arm assembly, and the actuator assembly further comprises:
a threaded pin passing through the hole and being fastened at the registration nut washer to provide additional clamp pressure and rigidity to the stacked actuator arm assembly; and
the registration nut washer has a extension for a hole receiving the threaded pin and the extension engages a registration surface in the overmold to register the nut washer in rotational position to the overmold.
